(19) United States
(12) Patent Application Publication
(10) Pub. No.: US 2006/0185230 A1
(43) Pub. Date: Aug. 24, 2006

(54) Vegetation barrier

(76) Inventors: Don Nablo, Marietta, GA (US); Cindy Nablo, Marietta, GA (US); Steve Pedersen, Rochester, MN (US)

Correspondence Address: NEEDLE & ROSENBERG, P.C., SUITE 1000, 999 PEACHTREE STREET, ATLANTA, GA, 30309-3915, US

(21) Appl. No.: 11/328,446

(22) Filed: Jan. 9, 2006

Related U.S. Application Data
(60) Provisional application No. 60/642,758, filed on Jan. 10, 2005.

(51) Int. Cl. A01G 13/02

(52) U.S. Cl. 47/31

(57) ABSTRACT

An improved vegetation barrier comprised of vegetation barrier sheet having a predetermined shape or form and a semi rigid peripheral support member connected to at least a portion of the peripheral edge of the landscape fabric.

### CROSS REFERENCE TO RELATED APPLICATIONS

This application claims priority to U.S. provisional patent application Ser. No. 60/642,758 filed in the United State Patent and Trademark Office on Jan. 10, 2005, the disclosure of which is hereby incorporated by reference in its entirety for all purposes.

### BACKGROUND OF THE INVENTION

When planting gardens and ornamental planting areas weed growth becomes a problem as the growing season progresses. To prevent the weed growth from dampening the aesthetic appeal of the garden area, additional effort and time must be expended to maintain the planting area.

Several landscaping products are currently available for inhibiting such weed growth however these products are typically bulky and difficult to use. Thus, there is a need in the art for a product that can inhibit weed growth, be convenient to use, and that is environmentally safe.

### SUMMARY OF THE INVENTION

In one embodiment, the vegetation barrier of the present invention comprises a vegetation barrier sheet having a preformed shape and peripheral support member having substantially the same shape as the vegetation sheet. In one aspect, the vegetation barrier sheet is positioned in overlying registration to and adhered to the peripheral support member.

Related methods of manufacture and operation are also provided. Other systems, methods, features, and advantages of the vegetation barrier will be or become apparent to one of ordinary skill in the art upon examination of the following figures, claims, and detailed description. It is intended that all such additional systems, methods, features, and advantages be included within this description, be within the scope of the vegetation barrier, and be protected by the accompanying claims.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is an exploded view of a vegetation barrier according to one aspect of the present invention.

FIG. 2 is a top plan view of an exemplary arrangement of a plurality of inventive vegetation barriers according to one aspect of the present invention.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “peripheral support member” includes aspects having two or more such peripheral support members unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As briefly summarized above, the present invention is directed to an improved vegetation barrier comprised of landscape fabric having a predetermined shape or form and a semi-rigid peripheral support member connected to at least a portion of the peripheral edge of the landscape fabric. To this end, landscaping fabric is commonly used today in landscaped areas for resisting the growth of weeds and other unwanted plant life. Conventional landscape fabrics typically consists of an opaque film of polyester or polyethylene, typically black or grey in color, and having a thickness of, for example, 3-6 mils. These fabrics are typically packaged as rolls approximately 3 feet in width and up to 50 feet in length. These rolls of landscape fabric are generally bulky and can be relatively difficult to manipulate, especially in circumstances where a relatively small landscape area is to be covered with a vegetation barrier. The inventive vegetation barrier overcomes the difficulty in handling conventional landscape fabrics through its unique design.

Broadly speaking, the inventive vegetation barrier is comprised of any conventional landscaping fabric having a predetermined shape and size. A semi-rigid peripheral support member is affixed to at least a portion of the peripheral edge of the preformed landscape fabric. The peripheral support member in one aspect has a preformed shape that corresponds to at least a portion of the peripheral shape of the landscape fabric. The resulting vegetation barrier provides a convenient, semi rigid, preformed landscape fabric that can be easily positioned on a desired landscape application site by anyone from the novice gardener to the professional landscaper without requiring the handling and shaping of bulky conventional rolls of landscape fabric.

The preformed vegetation barrier can comprise any conventional or otherwise commercially available landscape fabric that is capable of providing a suitable vegetation barrier in a desired landscape application site. For example, in one aspect, the landscape fabric can be an unwoven polyester fabric such as the gray polyester spunbonded (non-woven) landscape fabric available from Shaw Fabric Products. Since conventional landscape fabrics are packaged in rolls approximately 3 feet in width and up to 50 feet in length, the landscape fabric can be cut from such a roll to provide a fabric having any desired size and shape. For example, in an exemplary aspect and without limitation, the landscape fabric can be shaped to provide a round, rectangular, square, elliptical, oval, hexagon, octagon, triangular, or any other desired preformed shape. Additionally, the landscape fabric can be sized to provide an inventive vegetation barrier having a maximum width in the range of from, for example, 6 inches to 36 inches, including maximum widths or 8 inches, 12 inches, 16 inches, 18 inches or even 20 inches.

In one aspect, the sheet of landscape fabric can be sized and shaped such that when tensioned to provide a substantially planar sheet, the periphery of the landscape fabric defines an area that is at least substantially the same as the area defined by the periphery of corresponding peripheral edge of the semi-rigid support member. Alternatively, the landscape fabric can be sized and shaped such that when tensioned to provide a substantially planar sheet, the periphery of the landscape fabric defines an area that is greater than the area defined by the peripheral edge of the semi-rigid support member. To this end, it will be appreciated that the latter described aspect provides an inventive vegetation barrier having an excess of landscape fabric sufficient to enable the landscape fabric to at least partially conform to the topographic contour of a desired landscape application site.

The semi-rigid peripheral support member can be formed from any material that is capable of providing an at least semi-rigid support structure to at least a portion of the peripheral edge of the landscape fabric. As used herein, the term semi-rigid refers to a degree of pliancy or stiffness that is greater than the pliancy or stiffness of a single ply or single layer of the selected landscape fabric. Thus, it should be understood that as used herein, semi-rigid is in one aspect a relative term used to characterize a peripheral support member that is capable of adding support to a single ply of landscape fabric and is not intended to be limited to any particular degree of stiffness or pliancy. Therefore, it should be understood that in another aspect, the semi-rigid support member can still be sufficiently pliable to at least partially conform to the topographic contour of a particular landscape application site. To that end, the semi-rigid peripheral support member can be formed from such exemplary materials as paper, cardboard, recycled paper or cardboard, plastic, wood, Styrofoam, or even fabric. In still another aspect, the semi-rigid support member can also be biodegradable.

In one aspect, the at least semi-rigid peripheral support member can be manufactured from a wax or clay coated paper board. An exemplary coated paperboard can be 0.22 mil Clay Coated News Board, commonly referred to as CCNB. In still another aspect, an exemplary peripheral support member can be formed by a plurality of two or more plies or layers of the landscape fabric. The plies or layers can be formed by one or more folds of single continuous sheet of landscape fabric or, alternatively, can be formed by a plurality of separate and distinct layers of fabric positioned in overlying registration with one another.

As stated above, the peripheral support member can be sized and shaped to complement the preformed size and shape of the landscape fabric as described above. Thus, it should be understood that in an exemplary aspect and without limitation, the peripheral support member can be sized and shaped to provide a round, rectangular, square, elliptical, oval, hexagon, octagon, triangular, or any other desired preformed shape as well. Additionally, and to further complement the size and shape of the preformed landscape fabric, the peripheral support member can also be sized to provide a maximum width or diameter in the range of from, for example, 6 inches to 36 inches, including maximum widths or 8 inches, 12 inches, 16 inches, 18 inches or even 20 inches.

The landscape fabric can be affixed to the peripheral support member by any conventional means. In one aspect, the peripheral support member can be sewn or stitched to the landscape fabric. Alternatively, the peripheral support member can be affixed to the landscape fabric using a suitable adhesive composition. As one of skill in the art will appreciate, a suitable adhesive composition can depend upon the material selected for use as the peripheral support member as well as the particular landscape fabric. In one aspect, the suitable adhesive composition can be any commercially available epoxy resin. In still another aspect, a suitable adhesive composition can comprise any commercially available polymeric adhesive or glue such as Elmer's Polyurethane Ultimate Glue (Elmer's Products Model # P9412). To this end, it will be appreciated that in one aspect it is desired for the adhesive to be weather resistant or even weather proof, i.e., water resistant and/or water proof.

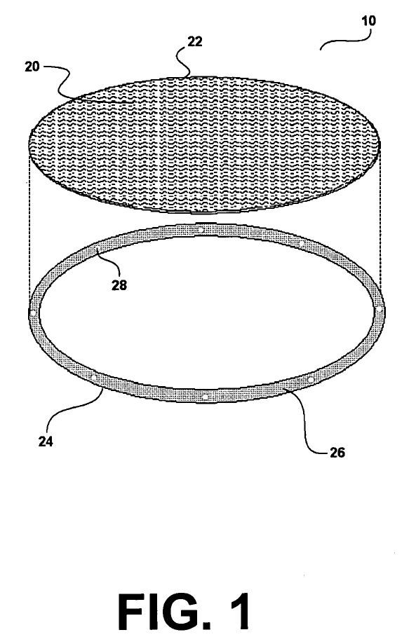

With reference to FIG. 1, an exploded view of an exemplary vegetation barrier 10 according to the present invention is shown. The vegetation barrier as shown comprised of a landscape fabric 20 having a preformed substantially circular shape. The preformed landscape fabric further comprises a peripheral edge portion 22. A peripheral support member 24 is also provided having a substantially circular shape that is sized and shaped to complement the peripheral edge of the landscape fabric. An adhesive composition 26 is applied to at least a portion of the peripheral support member such that the peripheral edge of the landscape fabric can be affixed to the top surface portion of the peripheral support member. As further shown, one or more option apertures 28 can also be formed by the peripheral support member. The optional apertures 28 can be sized and shaped to receive a stake or other substantially upright support member that can be driven into the desired landscape application site in order to retain the vegetation barrier in a desired position.

Slits can optionally be preformed and provided in the inventive vegetation barrier or they can optionally be cut by the end user in the landscape fabric to a sufficient size to permit vegetation, such as young trees, bushes, perennials, annuals, and the like to be planted there through. To that end, in an exemplary aspect, the inventive vegetation barrier can comprise a plurality of two or more intersecting slits cut in the landscape fabric and forming, for example, an “X” in the landscape fabric. Each slit can be any desired length and positioned in any desired location of the landscape fabric, however, in one aspect, two slits having respective lengths of approximately 3 inches can be provided such that they form an “X” pattern in or near the center of the vegetation barrier.

In use, a vegetation barrier according to the present invention may be placed on a desired landscape application site. After the planting has been completed, the entire area may optionally be covered with several inches of mulch such as bark chips or shredded hardwood, decorative rock or gravel if a permanent landscape project. For crop use, such as strawberries or tomatoes, mulch is not used. As moisture enters the landscaped area, as by rain or sprinkling, the water seeps through the mulch, rock or gravel and eventually passes through landscape fabric. Since sunlight will not sufficiently be transmitted below the landscape fabric 20, seeds of weeds and other undesirable plants cannot easily propagate, and if germination does occur life cannot continue in the absence of light.

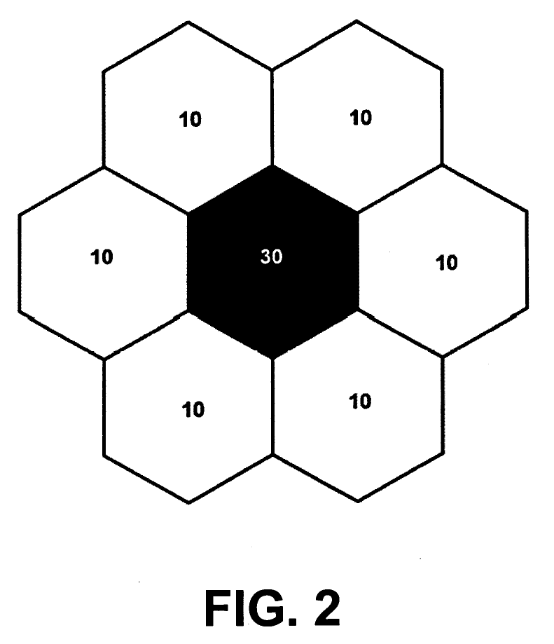

Still further, a plurality of the inventive vegetation barriers can also be placed on a landscape application site to form any desired pattern of side by side and/or spaced apart inventive vegetation barriers. For example, in one aspect, and as shown in FIG. 2, a plurality of 6 vegetation barriers 10 having an exemplary hexagonal shape can be placed adjacent to one another in a ring formation. As shown, the exemplified application of the inventive barriers can be such that a portion 30 of the application site remains uncovered and can, for example correspond to a desired location for planting select vegetation. However, it should also be understood that, if desired, still a seventh hexagonal vegetation barrier 10 can also be applied to the uncovered portion 30 resulting in a larger continuous aggregate vegetation barrier.

The above specification, examples and data provide a complete and exemplary description of the manufacture and use of the present invention. Since many embodiments of the invention can be made without departing from the spirit and scope of the invention, the invention resides in the claims hereinafter appended.

### PROPHETIC EXAMPLE

An exemplary vegetation barrier according to the present invention could be manufactured according to the following procedure. First, a conventional die cutter can be set up to cut desired shapes for the peripheral support member. To this end, wax coated paperboard could be passed through the die cutter to provide, for example, a peripheral support ring having a hexagonal shape or circular shape that is approximately 8 inches, 12 inches, or even 18 inches in diameter.

A suitable adhesive composition can then be applied to the top surface portion of the formed wax coated paper ring. An appropriate length of landscape fabric can be cut and placed upon the surface of the peripheral support member having a layer of adhesive deposited thereon. A conventional roller can also be used to ensure sufficient contact between the adhesive layer and the landscape fabric. After the adhesive is allowed to dry and/or cure at room temperature for approximately 10 minutes, the excess landscape fabric can be trimmed around the periphery of the support member to provide a finished product. If desired, the resulting product is then ready for use or can be packaged for resale.

What is claimed is:

1. A vegetation barrier comprising:
a) a vegetation barrier sheet having a preformed size and peripheral shape; and
b) a substantially planar peripheral support member having substantially the same preformed peripheral size and shape as the vegetation sheet;
wherein the vegetation barrier sheet is positioned in overlying registration to and adhered to the peripheral support member.

2. The vegetation barrier of claim 1, wherein the peripheral support member is a semi-rigid support member.

3. The vegetation barrier of claim 1, wherein the peripheral support member is comprised of Styrofoam, paperboard, fabric, or wood.

4. The vegetation barrier of claim 1, wherein the peripheral support member is comprised of wax or clay coated paperboard.

5. The vegetation barrier of claim 1, wherein the peripheral shape of the vegetation barrier sheet and the peripheral support member is circular, rectangular, octagonal, hexagonal, triangular, or elliptical.

6. The vegetation barrier of claim 1, wherein the peripheral support member and the vegetation barrier sheet have substantially circular peripheral shape.

7. The vegetation barrier of claim 1, wherein the peripheral support member forms a ring having a maximum width in the range of from 6 inches to 36 inches.

8. The vegetation barrier of claim 1, wherein the vegetation barrier sheet is opaque.

9. The vegetation barrier of claim 1, wherein the vegetation barrier sheet is substantially water permeable.

10. A method for manufacturing a vegetation barrier, comprising the steps of:
a) providing a peripheral support member having a preformed peripheral size and shape;
b) providing a substantially planar vegetation barrier sheet having a peripheral size and shape that is at least equal to or greater than the peripheral size and shape of the peripheral support member; and
c) adhering the vegetation barrier sheet in overlying registration to the peripheral support member.

11. The method of claim 10, wherein the peripheral support member is a semi-rigid support member.

12. The method of claim 10, wherein the peripheral support member is comprised of Styrofoam, paperboard, fabric, or wood.

13. The method of claim 10, wherein the peripheral support member is comprised of wax or clay coated paperboard.

14. The method of claim 10, wherein the peripheral size and shape of the provided peripheral support member and the peripheral size and shape of the barrier sheet are substantially the same

15. The method of claim 14, wherein the peripheral shape of the vegetation barrier sheet and the peripheral support member is circular, rectangular, triangular, octagonal, hexagonal, or elliptical.

16. The method of claim 14, wherein the peripheral support member and the vegetation barrier sheet have a substantially circular peripheral shape.

17. The method of claim 10, wherein the peripheral support member forms a ring member having a maximum width in the range of from 6 inches to 36 inches.

18. The method of claim 10, wherein the vegetation barrier sheet is opaque.

19. The method of claim 10, wherein the vegetation barrier sheet is substantially water permeable.

20. The vegetation barrier manufactured by the method of claim 10.
